(19) United States
(12) Patent Application Publication
(10) Pub. No.: US 2018/0276947 A1
(43) Pub. Date: Sep. 27, 2018

(54) METHOD OF ADMINISTERING CASINO BACCARAT WITH INDIVIDUAL PLAYER ASSIGNED PROGRESSIVE CARD COMBINATION

(71) Applicant: AGS LLC, Las Vegas, NV (US)

(72) Inventors: Ronald A. LaDuca, Millstone, NJ (US); Todd D. Fishon, Henderson, NV (US)

(21) Appl. No.: 15/466,432

(22) Filed: Mar. 22, 2017

(51) Int. Cl. G07F 17/32

(52) U.S. Cl. CPC G07F 17/3258; G07F 17/3288; G07F 17/323; G07F 17/322; G07F 17/3293

(57) ABSTRACT

An individualized progressive system for casino baccarat is disclosed. A method of administering a Baccarat casino card game in combination with an optional progressive jackpot bonus bet on individual player uniquely assigned ROYAL 9® card combinations of a face card and a nine card of specified suits. Each player position is assigned at least one unique ROYAL 9® card combination that will trigger the progressive jackpot award when a matching ROYAL 9® card combination appears in the dealt Banker Hand and/or Player Hand. Only one player at a time will win the progressive jackpot.

### CROSS-REFERENCE TO RELATED APPLICATIONS

The present utility patent application claims the benefit of prior Provisional Application No. 62/277,843 filed Jan. 12, 2016.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

### Field of the Invention

The present invention relates to casino card games and in particular to a method for administering a casino Baccarat card game having an individualized player progressive wager and payout by assigning each player position with at least one unique ROYAL 9® combination of cards, comprising a face card and a nine card, to match the community Player Hand and community Banker Hand to trigger a jackpot or progressive payout when the optional progressive bonus bet is placed by the player to allow the progressive jackpot to be won by only one of the players at the table.

### DESCRIPTION OF RELATED ART INCLUDING INFORMATION DISCLOSED UNDER 37 CFR 1.97 AND 1.98

In prior art casino Baccarat, the hands dealt are community hands (i.e. every player is making their individual wager based on the same combination of cards: a single player community hand and a single banker community hand). The prior art progressive Baccarat games offer a winning combination that is shared by all players resulting in the progressive jackpot being shared by all players. Prior art progressive Baccarat wagers have not been successful since everyone plays off of the same two community hands, so that the players would have to split the progressive prize.

Other baccarat progressives have a combination that initiates the progressive jackpot, but the combination is available to every player. When it hits, all the players that made the wager will split the prize.

In the prior art, if every player that makes the progressive wager splits the progressive jackpot when the winning combination is achieved, the value of the wager is decreased. Players are better off playing alone on the table to maximize the value of the wager. The more people playing, the less money each player will win when the jackpot is initiated.

Mathematically in the prior art, when more than one player at a table is making the progressive wager in a shared jackpot using only the shared community cards, the more players that play the shared progressive jackpot at a table diminishes the value of each players wager.

A number of prior art patents show different kinds of progressive bets on cards dealt in the Baccarat game, but all pay out progressive betting players equally since the hands are based strictly upon all players using the same two sets of community cards, the player cards and the banker cards.

U.S. Pat. No. 5,876,283 filed 30 Oct. 1997 by Parra et al, shows an improved method of playing the conventional manner of play of baccarat and game table apparatus in which a bettor makes a first wager that either a bank hand or player hand will win, the improvement comprising: the bettor having the option of making a second wager that the bank hand and the player hand will comprise in combination a four-of-a-kind of a specific card value, dealing two cards comprising the bank hand and dealing two cards comprising the player hand according to the conventional manner of play of baccarat, determining whether the combination of the bank hand and the player hand is a four-of-a-kind of the specific card value, paying off the bettor a predetermined amount if the bettor's second wager was a winning wager wherein the combination of the bank hand and the player hand is a four-of-a-kind of the specific card value, dealing an additional card to the player hand and an additional card to the bank hand if required according to the conventional manner of play of baccarat, determining a winning hand and a losing hand according to the conventional manner of play of baccarat, paying off the bettor a predetermined amount if the bettor's first wager was on the winning hand according to the conventional manner of play of baccarat and collecting the amount wagered on the losing hand. The game table apparatus comprising: a game board having a generally semicircular peripheral edge about which a plurality of players are located, the game board having designated thereon a series of bet placing boxes corresponding to each of the players and a plurality of ornamental designs corresponding to each of the players, each of the ornamental designs being located at each of the bet placing boxes. The bettor has the option of making the second progressive jackpot wager that the bank hand and the player hand will comprise in combination a four-of-a-kind of a specific card value in which the specific card value is determined by a seat location number at which the bettor is located.

International patent application #PCT/CA2006/001295 published 15 Feb. 2007 by Chun, claims a method of playing a live baccarat game which allows a player to bet on jackpot, comprising dealing cards to a player hand and a bank hand according to a set of conventional baccarat rules, allowing at least a first player to place a bet on live baccarat, allowing at least a second player to place a bet on jackpot where the second player can be the same as or different from the first player, determining the outcome of the live baccarat game according to the set of conventional baccarat rules, and determining the outcome of the jackpot according to a combination of cards that comprises at least one zero-point cards.

U.S. Patent Application #20080296840 filed by Snow, describes a method of playing a game of baccarat with an optional side bet. According to the method, at least one player places a Baccarat Wager. Each player also optionally places a side bet wager. The dealer initially deals at least one initial two-card player hand and the initial two-card banker hand. The game of baccarat is played to conclusion according to conventional baccarat rules. Hands receive an additional card according to the traditional rules of Baccarat. The side bet wager is resolved after all the cards in the baccarat game are revealed. Payouts are made on predetermined winning hand combinations made from all available player and banker cards. Preferred winning hand combinations are runs of three of more cards of the same rank. Payouts may be fixed amounts, may pay odds on the original wager, and may be progressive or combinations thereof. The top payout may be split amongst players participating in the side bet.

U.S. Pat. Nos. 6,837,494 and 6,588,758 issued to Lee, show a method of playing a combined poker and baccarat-type card game. The method comprises dealing 3 cards to both a banker hand and a player hand, with the winning baccarat hand having a higher hand value based on the traditional baccarat scoring system, but without all of the complex baccarat rules for determining if and when a third card is to be dealt. Included is a side bet in which the option of any player to select that the player hand of three cards or the banker hand of three cards or both the player hand and the banker hand will provide a bonus poker hand.

U.S. Pat. No. 5,395,119 issued to Jacob et al, provides additional options for the placement of wagers in the game of baccarat. The various betting or wagering options include the placement of bets on a “natural” hand(s), “super tie” wagers, in which a player may bet on player and banker hands of identical count which each have a predetermined value, and “jackpot” ties. Jackpot ties are similar to super ties but also require every card in the two hands to be of the same value, i.e., 4 of a kind. Yet another option is that of betting on the occurrence of flush hands.

U.S. Pat. Nos. 7,032,902; 6,637,748 and 6,371,484 all issued to Yuan, claims a game in which players place a base wager on either a first hand or a second hand. Proposition wagers for pushes, ties, and bonus holdings may be placed. Three cards are dealt to a first and a second hand. Either hand may automatically win if it includes a predetermined three-card combination.

U.S. Pat. No. 6,345,824 issued to Selitzky, discloses a bonus method for a casino card game, such as Blackjack or Baccarat that begins with the player making an ante wager and a first and second bonus wager. The player and dealer are each dealt a hand of cards, or electronic representations thereof. The player plays the player's hand to completion and is rewarded based on the player's first bonus wager if the player's hand includes a predetermined bonus combination.

What is needed is to provide an individualized progressive jackpot system for casino Baccarat wherein each player position is assigned at least one unique Royal 9 combination, comprising a face card and a nine card, to match the player hand and the banker hand that will trigger the progressive jackpot award, which will allow for only one player at the table to win the progressive jackpot award exclusively.

### BRIEF SUMMARY OF THE INVENTION

An object of the present invention is to provide an individualized progressive system and method for casino Baccarat wherein each player position is assigned at least one unique Royal 9 combination, comprising a face card and a nine card of designated suits, that will trigger the progressive jackpot award, which will allow for only one player at the table to win the prize so that since each player has their own unique combination which, when achieved, will pay the player wagering in that player position that is assigned the combination 100% of the jackpot's accrual and starting value.

A related object of the present invention is that providing only one winning combination, the frequency of winning the wager will be greater with each player having at least one unique Royal 9 combination so that there is a greater chance of the jackpot being initiated along with a greater reward for the one player that wins the jackpot.

In brief, the present invention provides a method for administering a casino Baccarat card game having an individualized player progressive wager and payout by assigning each player position with at least one unique ROYAL 9® combination of cards, comprising a face card and a nine card, to match the community Player Hand and community Banker Hand to trigger a jackpot or progressive payout when the optional progressive bonus bet is placed by the player to allow the progressive jackpot to be won by only one of the players at the table.

Herein defined, ROYAL 9® designates a nine card and any face card (Jack, Queen, or King) in the initial two cards dealt to a Player Hand or a Banker Hand, which is a specific face card type of “natural” winning Baccarat hand totaling nine points. The optional ROYAL 9® progressive wager of the present invention is paid out to specific face card and nine card combinations according to a two-tiered ROYAL 9® Progressive Payout Table.

A Personal ROYAL 9® Progressive Payout Table awards at least one type of single cumulated Progressive jackpot to only one player having a uniquely assigned ROYAL 9® card combination appearing in one or both of the initial dealt two card

Banker Hand or Dealer Hand. Each player layout preferably has three assigned unique ROYAL 9® card combinations: a King card and a 9 card each of a specific suit, a Queen card and a 9 card each of a specific suit, and a Jack card and a 9 card each of a specific suit, wherein none of the other player positions have the same ROYAL 9® card combinations.

There are preferably three different Personal ROYAL 9® Progressive Jackpots designated in the Personal ROYAL 9® Progressive Jackpot Payout Table utilizing only the unique assigned ROYAL 9® card combinations on each player layout:

A Major ROYAL 9® Progressive Jackpot designates the progressive jackpot meter that represents both the Player Hand and the Banker Hand containing the same one of the player layout unique assigned progressive ROYAL 9® combinations.

A King/9 Banker Progressive Jackpot designates the progressive jackpot meter that represents the Banker Hand containing a player layout unique assigned King/9 progressive combination.

A King/9 Player Jackpot designates the progressive jackpot meter that represents the Player Hand containing a player layout unique assigned King/9 progressive combination.

Personal ROYAL 9® Progressive Combinations Payouts—each betting position has three unique combinations that can trigger a progressive payout:
1) Exact Match Personal ROYAL 9® Progressive Combination pays 100% of the Major Jackpot—The player hand and banker hand both have the exact same unique personal progressive combination assigned to a player layout.
2) Any Two Personal ROYAL 9® Progressives Combinations pay 10% of the Major Jackpot—the player hand and banker hand each contain a personal progressive combination assigned to a betting position.
3) Personal King/9 on Banker Hand pays 100% of the King/9 Banker Progressive Jackpot—The Banker hand contains a King/9 combination uniquely assigned to a player layout.
4) Personal King/9 on Player Hand pays 100% of the King/9 Player Progressive Jackpot—The Player hand contains a King/9 combination assigned to a betting position.

A general ROYAL 9® Progressive Payout Table relates to ROYAL 9® card combinations in the Banker Hand and Player Hand which are paid out to any player making the optional ROYAL 9® Progressive Bonus bet and not having the unique assigned ROYAL 9® card combination in the player's layout. If a player is entitled to a Personal ROYAL 9® Progressive Jackpot payout because the Banker Hand or Player Hand contain any of the player's unique assigned ROYAL 9® card combinations, the player is paid the Personal ROYAL 9® Progressive Jackpot payout and not the smaller payout. The general ROYAL 9® Progressive Payout Table designates payouts on ROYAL 9® card combinations as follows:
a) Any ROYAL 9°—either the Player Hand or the Banker Hand contains a ROYAL 9® card combination
b) Any Suited ROYAL 9®—either the Player Hand or the Banker Hand contains a ROYAL 9® where both cards are of the same suit
c) Royal 9 Tie Hand—both the Player Hand and the Banker Hand each have a
ROYAL 9®; not necessarily the same ROYAL 9® combination
d) Suited ROYAL 9® Tie Hand—both Player Hand and the Banker Hand each have a suited ROYAL 9®; not necessarily the same suited ROYAL 9®

“Progressive Sensor” designates the betting spot for the ROYAL 9® progressive wagers, having an electronic sensor to detect the optional ROYAL 9® Progressive Bonus Wager placed there.

“Starting Meter” designates the starting amount of a progressive jackpot.

“Increment Rate” designates the percent of each dollar wagered that goes to the progressive jackpot meter.

“Secondary Seed” designates the percent of each dollar that is accrued in a fund that will be added to the Starting Meter after a progressive jackpot is won.

The present invention can be used as a table game in a casino where it is facilitated by a real person (dealer) or can be used as an electronic device with virtual cards randomly selected and the electronic device settling the outcome of each round.

A primary advantage of the present invention is that it provides an opportunity for an individual player to win a large unique progressive jackpot not shared by the other players.

Another advantage is that it provides all players with an opportunity to increase winnings with an optional bet that is shared on an equal basis with the other players for winning bonus card combinations in the community Banker Hand and Player Hand.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a plan view of a Baccarat casino card game layout in combination with an optional progressive award bonus bet on a ROYAL 9® card combination of the present invention on a casino card playing table layout for carrying out the steps of the method of the present invention, showing the player layouts, each including three assigned unique ROYAL 9® card combination and payout tables, facing the players and the dealer layout and payout tables facing the dealer on the other side of the playing table from the players;

FIG. 2 is an exploded plan view of a player layout from FIG. 1, showing betting locations, three uniquely assigned ROYAL 9® card combinations and the progressive payouts;

FIG. 3 is an elevational view of an electronic ROYAL 9® progressive meter display at a location visible to each player at the playing table, showing one Major ROYAL 9® progressive jackpot meter indicating the cumulative payout amount and a ROYAL 9® payout table showing personal and community progressive payouts;

FIG. 4 is an elevational view of an electronic ROYAL 9® progressive meter display at a location visible to each player at the playing table, showing one Major ROYAL 9® progressive jackpot meter, a King 9 Banker Hand Progressive meter, and a King 9 Player Progressive meter indicating the cumulative payout amounts and a ROYAL 9® payout table showing personal and community progressive payouts;

FIG. 5 is an elevational view of the Baccarat casino card game layout in combination with an optional progressive award bonus bet on a ROYAL 9® card combination layout of the present invention shown on a screen of an electronic simulation device showing a simulation of the player layouts and payout tables and the dealer layout and payout tables and including the three uniquely assigned player ROYAL 9® card combinations;

FIG. 6 is an elevational view of the Baccarat casino card game layout in combination with an optional progressive award bonus bet on a ROYAL 9® card combination layout of the present invention shown on a screen of a computer device showing a simulation of the Banker Hand, the Player Hand, the player layouts and payout tables and the dealer layout and payout tables, and the three uniquely assigned player ROYAL 9® card combinations;

FIG. 7 is an elevational view of the Baccarat casino card game layout in combination with an optional progressive award bonus bet on a ROYAL 9® card combination layout of the present invention shown on a touch screen of a wireless cell phone or tablet type device showing a simulation of the Banker Hand, the Player Hand, the player layout and payout table including the three uniquely assigned ROYAL 9® card combinations.

### DETAILED DESCRIPTION OF THE INVENTION

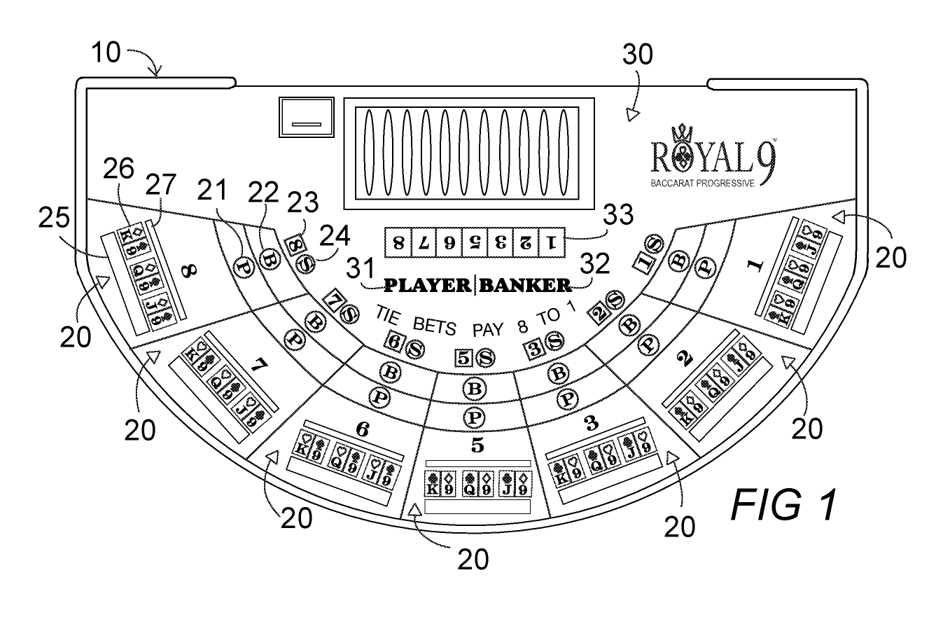

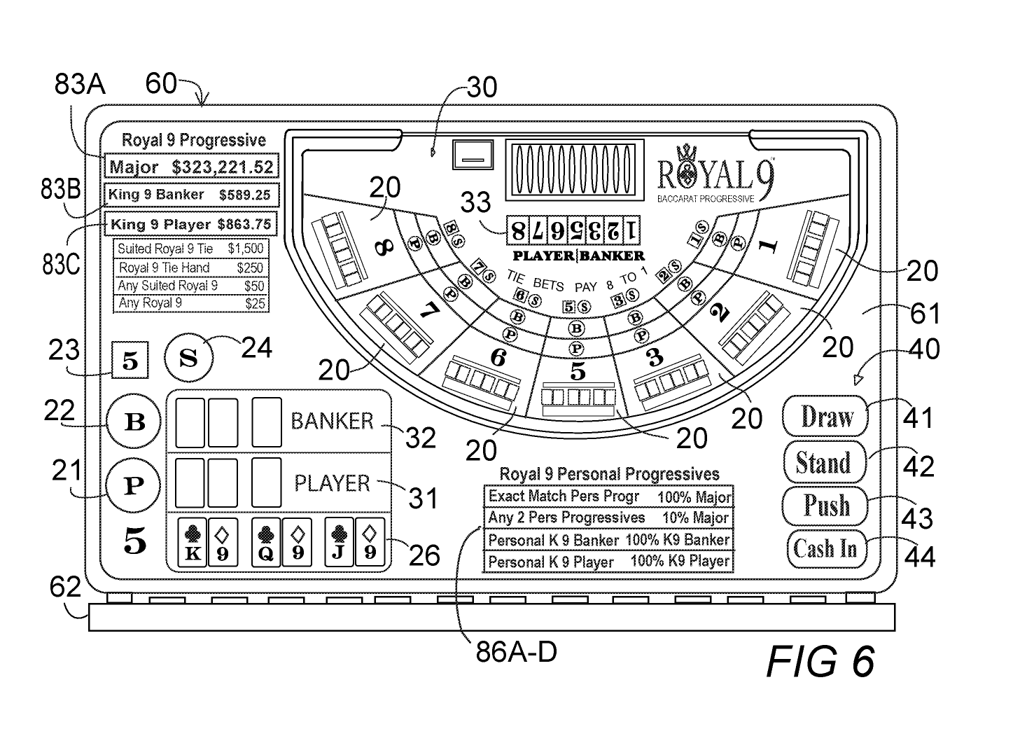

In FIGS. 1-7, the present invention comprises a method of administering a Baccarat casino card game in combination with an optional progressive award bonus bet on a ROYAL 9® card combination consisting of a face card and a nine card including at least one unique individual player ROYAL 9® card combination 26 of a face card and nine card combination of specified suits assigned to each player position 20. The method comprises:

Providing at least one playing table 10, each of the at least one playing tables comprising a surface illustrated to define a dealer layout area 30 and a plurality of player layout areas 20, each player layout area of the plurality of player layout areas illustrated to define a plurality of distinct locations comprising a Baccarat Player Hand win betting location 21, a Baccarat Banker Hand win betting location 22, a Baccarat Banker Hand and Baccarat Player Hand tie betting location 23, a ROYAL 9® progressive optional bonus betting location 24 for dealt Banker Hand and Player Hand ROYAL 9® card combinations of a face card and a nine card progressive award bonus wins, a unique ROYAL 9® card combinations location 26 indicating at least one unique player individually assigned ROYAL 9® card combination of a face card and a nine card of specified suits, and a ROYAL 9® card combination progressive payout table 25;

Providing at or proximate to the at least one playing table at least one standard 52-card deck of physical playing cards randomized to form at least one 52-card deck of Baccarat physical playing cards;

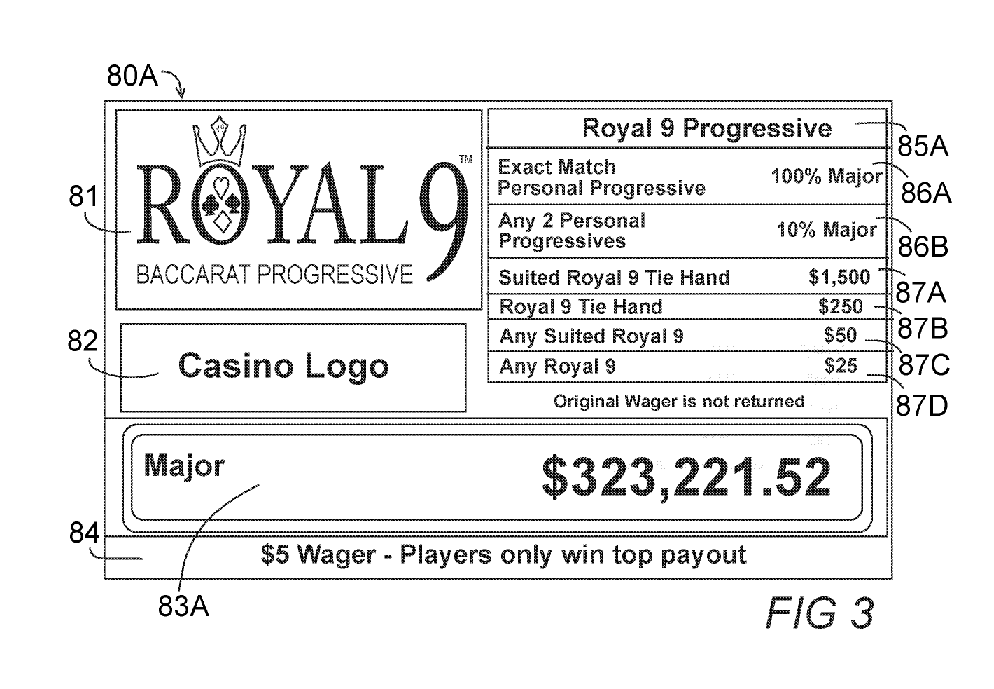

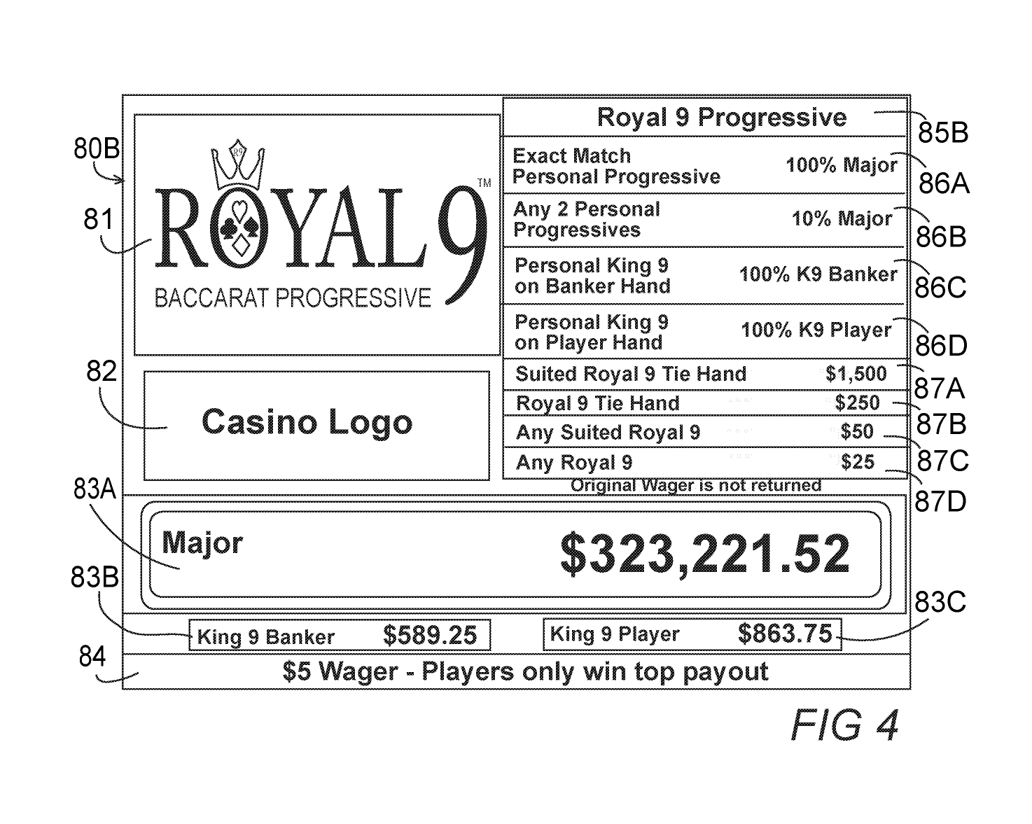

Providing an electronic means under each player optional bet location 24 for sensing and reporting ROYAL 9® progressive bonus bets at the at least one playing table 10 (preferably a radio wave detector sensing the placement of a progessive betting chip containing a transmitter on the sensor optional progressive betting location 24), and programmable means for calculating a percentage of the ROYAL 9® progressive bonus bets to create at lesat one ROYAL 9® Progressive cumulative jackpot and providing at least one electronic ROYAL 9® progressive meter display 80A and 80B, as shown in FIGS. 3 and 4, at a location visible to each player at each playing table, and an electronic means for updating the ROYAL 9® progressive meter display with at least one ROYAL 9® progressive jackpot cumulative payout amount 83A based on a percentage of all ROYAL 9® progressive bonus bets made;

Receiving one bet taken from one of the three Baccarat alternate betting locations including a Baccarat Player Hand win bet, a Baccarat Banker Hand win bet, or a Baccarat Banker Hand and Baccarat Player Hand tie bet in the form of at least one physical physical monetary token placed in the associated Baccarat Player Hand betting location, the Baccarrat Banker Hand win betting location, or the Baccarat Banker Hand and Baccarat Player Hand tie betting location of each player layout area of the plurality of player layout areas where a bet has been made;

Receiving an optional ROYAL 9® progressive bonus bet, such as a $5 chip, in the form of at least one physical monetary token placed in the ROYAL 9® progressive optional bonus betting location 24 of each player layout area 20 of the plurality of player layout areas where a bet has been made;

Recording and locking in all ROYAL 9® bonus wagers in dealer progressive betting demarcation boxes 33 corresponding to each player locations (1-3 and 5-8) of players making the progressive bet;

Collecting all ROYAL 9® bonus wagers;

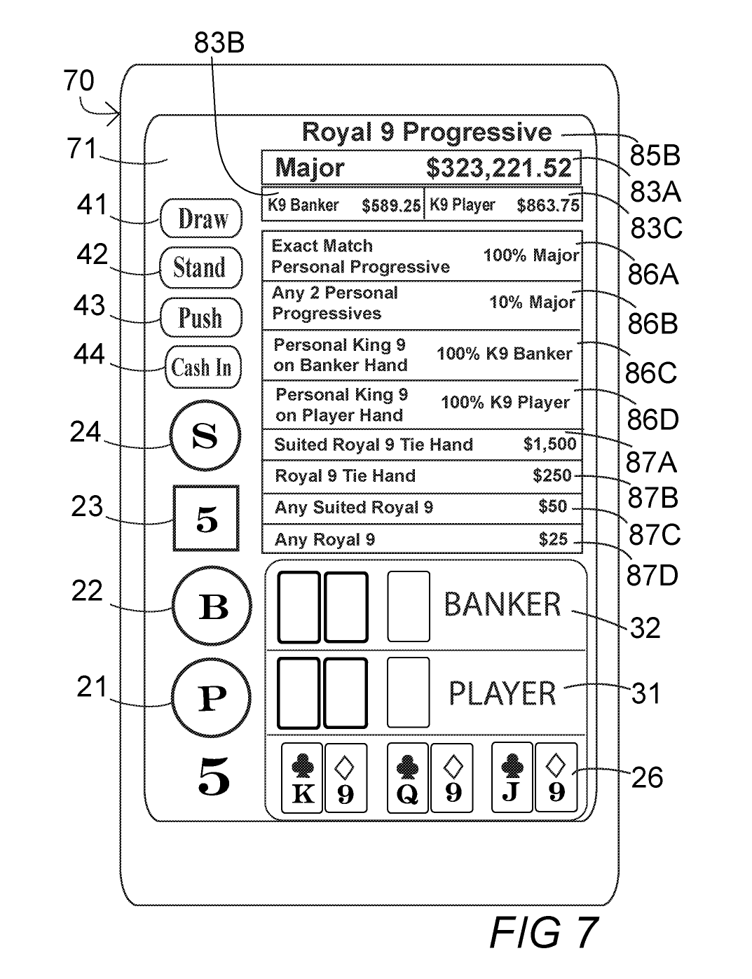

Distributing, on the surface of the playing table and from the at least one randomized 52-card deck of physical Baccarat playing cards, a two-card face-up Baccarat Banker Hand 32 and a two-card face-up Baccarat Player Hand 31 as shown in FIGS. 1 and 7;

Analyzing the initial dealt two-card face-up Baccarat Banker Hand 32 and the initial dealt two-card face-up Baccarat Player Hand 31 to determine if the Baccarat Player Hand, the Baccarat Banker Hand, or both contain a ROYAL 9® card combination:

Paying out any winning ROYAL 9® progressive bonus bets according to the ROYAL 9® progressive payout table 85A and 85B, as shown in FIGS. 3 and 4;

Playing out the Baccarat hand in accordance with approved Baccarat procedures.

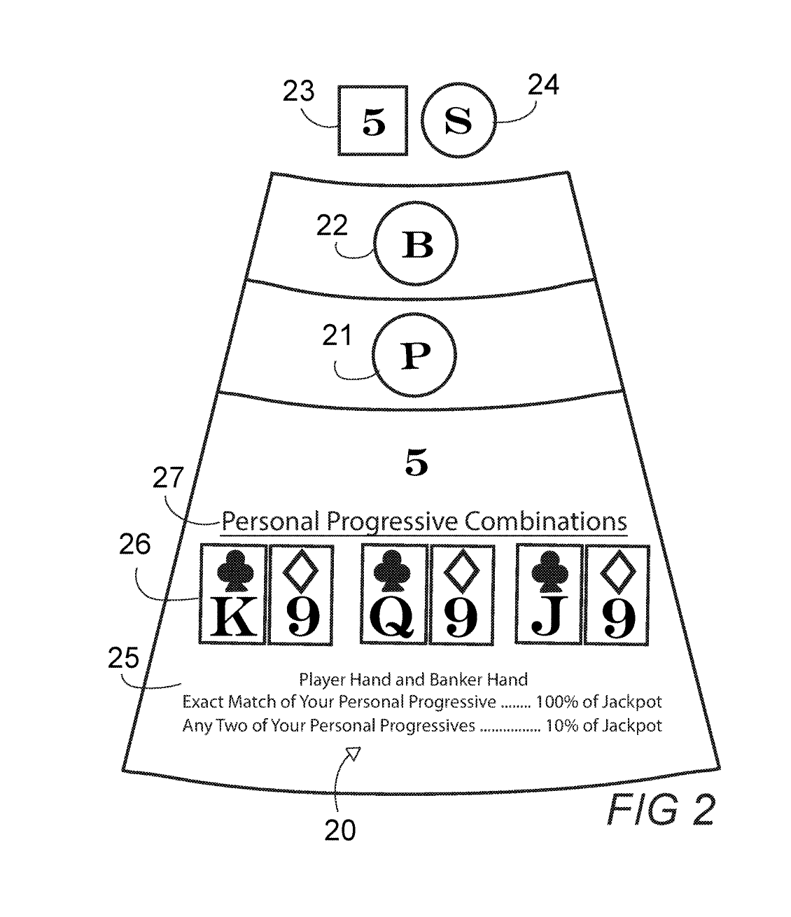

The player layout location 20, as shown in FIG. 2 indicating at least one unique player individually assigned ROYAL 9® card combination comprises a location indicating three unique ROYAL 9® combinations 26 assigned to the single player location comprising a unique King and Nine card combination, a unique Queen and Nine card combination, and a unique Jack and Nine card combination; and paying out any winning ROYAL 9® Progressive bonus bets according to the ROYAL 9® card combination Personal Progressive payout table 80A, as shown in FIG. 3, comprises paying out to a ROYAL 9® progressive optional bonus betting player as follows:

100% of a Major Progressive meter 83A for an Exact Match Personal Progressive, having both the Banker Hand 32 and the Player Hand 31 exactly matching one of the optional bonus betting player's uniquely assigned ROYAL 9® card combinations 26 (as indicated in line 86A of the ROYAL 9® Progressive payout table 85A of FIG. 3 and table 85B of FIG. 4);

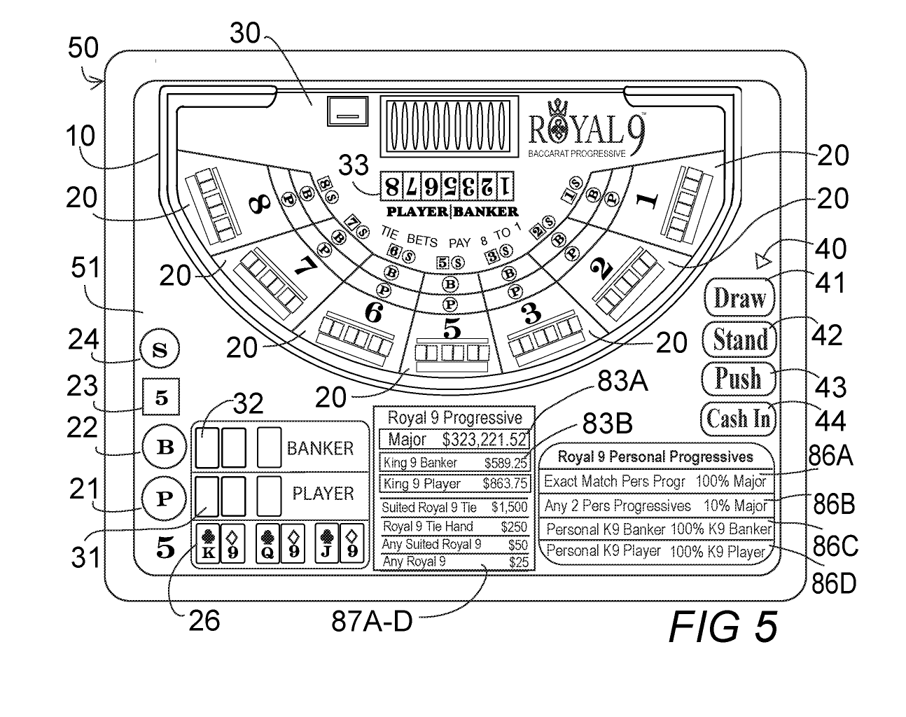

10% of the Major Progressive meter 83A for Any Two Personal Progressives, having the Banker Hand 32 matching one of the optional betting player's uniquely assigned ROYAL 9® card combinations and the Player Hand 31 matching another of the optional bonus betting player's uniquely assigned ROYAL 9® card combinations 26, as shown in FIGS. 5, 6, and 7 (as indicated in line 86B of the ROYAL 9® Progressive payout table 85A of FIG. 3 and table 85B of FIG. 4).

In FIG. 4, the method of claim 2 further comprising paying out any winning ROYAL 9® Progressive bonus bets according to the ROYAL 9® card combination Personal Progressive payout table 85B, shown in FIG. 4, comprising paying out to a ROYAL 9® Progressive optional bonus betting player:

100% of a King 9 Banker Progressive meter 83B for the Banker Hand 32 having a King 9 card combination matching the optional betting player's uniquely assigned King 9 card combination 26 (as indicated in line 86C of the ROYAL 9® Progressive payout table 85B of FIG. 4);

100% of a King 9 Player Progressive meter 83C for the Player Hand having a King 9 card combination matching the optional betting player's uniquely assigned King 9 card combination 26 (as indicated in line 86D of the ROYAL 9® Progressive payout table 85B of FIG. 4).

In lines 87A-87D of both ROYAL 9® Progressive payout tables 85A of FIGS. 3 and 85B of FIG. 4, the method shows paying out any winning ROYAL 9® Progressive bonus bets according to the ROYAL 9® card combination general Progressive payout table comprises paying out to a ROYAL 9® progressive optional bonus betting player:

$1,500 for any Suited ROYAL 9® Tie Hand (line 87A)

$250 for any ROYAL 9® Tie Hand (line 87B)

$50 for any Suited ROYAL 9® (line 87C)

$25 for any ROYAL 9® (line 87D).

In the event that a hand qualifies in multiple payouts, only the highest payout will be awarded to each player with an active ROYAL 9® progressive wager.

At least one standard 52-card deck of physical playing cards may comprise providing any of the numbers of standard 52-card decks of playing cards taken from the list of decks including one deck, two decks, four decks, six decks, and eight decks randomized to form a deck of Baccarat physical playing cards. The odds and payouts would change depending on the number of decks used.

Providing at least one playing table may comprise providing a plurality of playing tables all contributing to the ROYAL 9® progressive jackpot making the jackpot higher faster as the number of tables increases.

Providing a playing table may comprise providing a simulation device, which may be a mechanical simulatin device, comprising the surface displaying an illustration to define the plurality of player layout areas.

In FIGS. 5, 6, and 7, the method of the present invention may be carried out by providing an electronic simulation device comprising a screen configured to display a virtual representation of a playing surface illustrated to define a dealer layout area and a plurality of player layout areas, each player layout area of the plurality of player layout areas illustrated to define a plurality of distinct locations comprising a Baccarat Player Hand win betting location 21, a Baccarat Banker Hand win betting location 22, a Baccarat Banker Hand and Baccarat Player Hand tie betting location 23, a ROYAL 9® progressive optional bonus betting location 24 for dealt Banker Hand and Player Hand ROYAL 9® card combinations of a face card and a nine card progressive award bonus wins, a location indicating at least one unique player individually assigned ROYAL 9® card combination of a face card and a nine card of specified suits 26, and a ROYAL 9® card combination progressive payout table 85B, as shown in FIG. 7.

In FIGS. 5, 6, and 7, the method of the present invention using an electronic simulaton device 50, 60, and 70 involves providing at least one standard 52-card deck of virtual playing cards randomized to form at least one 52-card deck of virtual Baccarat playing cards. Providing at least one standard 52-card deck of virtual playing cards may comprise providing providing any of the numbers of standard 52-card decks of virtual playing cards taken from the list of numbers of standard 52-card decks of virtual playing cards including one deck, two decks, four decks, six decks, and eight decks randomized to form a virtual deck of Baccarat playing cards.

Further steps in the method of the present invention using an electronic ssimulation device comprise:

Providing an electronic means for recording individual player ROYAL 9® progressive bets on optional ROYAL 9® progressive award betting location 24 on the at least one virtual representation of a playing surface 51, 61, and 71and providing at least one virtual representation of a ROYAL 9® progressive meter display, and an electronic means for updating the ROYAL 9® progressive meter display with at least one ROYAL 9® progressive jackpot cumulative payout amount based on a percentage of all ROYAL 9® progressive bonus bets made;

Receiving one bet taken from one of the three Baccarat alternate betting locations including a Baccarat Player Hand win bet, a Baccarat Banker Hand win bet, or a Baccarat Banker Hand and Baccarat Player Hand tie bet, the bet in the form of at least one virtual monetary token virtually indicated in the associated Baccarat Player Hand betting location 21, the Baccarrat Banker Hand win betting location 22, or the Baccarat Banker Hand and Baccarat Player Hand tie betting location 23 of each player layout area of the plurality of player layout areas where a bet has been made.

Standard input means are used, such as a mouse, keypad, joystick, touchscreen or other electronic input means for selecting a location on the screen 50, 60, or 70 to carry out the steps of the method of the present invention using an electronic simulation device, including the following steps of:

Receiving an optional ROYAL 9® progressive bonus bet in the form of at least one virtual monetary token virtually indicated in the ROYAL 9® progressive optional bonus betting location 24 of each player layout area 20 of the plurality of player layout areas where a bet has been made;

Recording and locking in all ROYAL 9® bonus wagers;

Collecting all ROYAL 9® bonus wagers;

Virtually distributing, on the virtual representation of a playing surface, from the at least one randomized 52-card deck of virtual Baccarat playing cards, a two-card face-up Baccarat Banker Hand 32 and a two-card face-up Baccarat Player Hand 31;

Analyzing the initial dealt two-card face-up Baccarat Banker Hand and the initial dealt two-card face-up Baccarat Player Hand to determine if the Baccarat Player Hand, the Baccarat Banker Hand, or both contain a ROYAL 9® card combination:

Paying out any winning ROYAL 9® progressive bonus bets according to the Royal 9 card combination personal and community progressive payout tables as indicated above, but employing virtual payouts carried out electreonically.

Playing out the Baccarat hand in accordance with approved Baccarat procedures.

In FIG. 7, providing an electronic simulation device may comprise providing a handheld electronic simulation device 70, the screen 71 of the electronic simulation device configured as a touch screen of the handheld electronic simulation device.

Providing an electronic simulation device may comprise providing an electronic simulation device having a wired or wireless connection to a remote networkand may comprise providing a communication electronic simulation device, a computer, a handheld device, a telephonic device, an entertainment device, a gaming device, a television device, or other electronc simulation device.

Providing at least one electronic simulation device may comprise providing a plurality of electronic simulation devices all contributing to the ROYAL 9® progressive jackpot.

In use, as shown in FIG. 1, an example of the unique assigned ROYAL 9® card combinations for the optional personal ROYAL 9® progressive payouts are indicated for the individual player layouts as follows:

| | |
|---|---|
| Player layout 1 | King of Spades and 9 of Hearts |
| | Queen of Spades and 9 of Hearts |
| | Jack of Spades and 9 of Hearts |
| Player layout 2 | King of Spades and 9 of Diamonds |
| | Queen of Spades and 9 of Diamonds |
| | Jack of Spades and 9 of Diamonds |
| Player layout 3 | King of Clubs and 9 of Hearts |
| | Queen of Clubs and 9 of Hearts |
| | Jack of Clubs and 9 of Hearts |
| Player layout 5 | King of Clubs and 9 of Diamonds |
| | Queen of Clubs and 9 of Diamonds |
| | Jack of Clubs and 9 of Diamonds |
| Player layout 6 | King of Hearts and 9 of Spades |
| | Queen of Hearts and 9 of Spades |
| | Jack of Hearts and 9 of Spades |
| Player layout 7 | King of Hearts and 9 of Clubs |
| | Queen of Hearts and 9 of Clubs |
| | Jack of Hearts and 9 of Clubs |
| Player layout 8 | King of Diamonds and 9 of Spades |
| | Queen of Diamonds and 9 of Spades |
| | Jack of Diamonds and 9 of Spades |

Using multiple decks of cards enables winning combinations. Winning Personal ROYAL 9® Progressive Combinations for the above uniquely assigned player layout ROYAL 9® card combinations would be as follows:

Any Two Personal Progressives 10% of the Major Jackpot—Using the personal progressive combinations in player layout 1, below are the 6 winning combinations for the 10% Jackpot:

| Combination | Banker Hand | Player Hand |
|---|---|---|
| 1 | King Spades 9 Hearts | Queen Spades 9 Hearts |
| 2 | King Spades 9 Hearts | Jack Spades 9 Hearts |
| 3 | Queen Spades 9 Hearts | King Spades 9 Hearts |
| 4 | Queen Spades 9 Hearts | Jack Spades 9 Hearts |
| 5 | Jack Spades 9 Hearts | King Spades 9 Hearts |
| 6 | Jack Spades 9 Hearts | Queen Spades 9 Hearts |

Exact Match Personal Progressive 100% of the Major Jackpot—Using the personal progressive combinations in player layout 1, below are the 3 winning combinations for the 100% Jackpot:

| Combination | Banker Hand | Player Hand |
|---|---|---|
| 1 | King Spades 9 Hearts | King Spades 9 Hearts |
| 2 | Queen Spades 9 Hearts | Queen Spades 9 Hearts |
| 3 | Jack Spades 9 Hearts | Jack Spades 9 Hearts |

Personal King/9 on Banker hand for 100% of the King 9 Progressive jackpot—Using the personal progressive combinations in player layout 1, below is the 1 winning combinations for the 100% Jackpot:

| Combination | Banker Hand |
|---|---|
| 1 | King Spades 9 Hearts |

Personal King/9 on Player hand for 100% of the King 9 Progressive jackpot—Using the personal progressive combinations in player layout 1, below is the 1 winning combinations for the 100% Jackpot:

| Combination | Player Hand |
|---|---|
| 1 | King Spades 9 Hearts |

In the event that a hand qualifies in multiple payouts, only the highest payout will be awarded to each player with an active ROYAL 9® progressive wager.

It is understood that the preceding description is given merely by way of illustration and not in limitation of the invention and that various modifications may be made thereto without departing from the spirit of the invention as claimed.

1. A method of administering a Baccarat casino card game in combination an optional progressive award bonus bet on a ROYAL 9 card combination consisting of a face card and a nine card including at least one unique individual player ROYAL 9 card combination of a face card and nine card combination of specified suits assigned to each player position, the method comprising:
providing at least one playing table, each of the at least one playing tables comprising a surface illustrated to define a dealer layout area and a plurality of player layout areas, each player layout area of the plurality of player layout areas illustrated to define a plurality of distinct locations comprising a Baccarat Player Hand win betting location, a Baccarat Banker Hand win betting location, a Baccarat Banker Hand and Baccarat Player Hand tie betting location, a ROYAL 9 progressive optional bonus betting location for dealt Banker Hand and Player Hand ROYAL 9 card combinations of a face card and a nine card progressive award bonus wins, a location indicating at least one unique player individually assigned ROYAL 9 card combination of a face card and a nine card of specified suits, and a ROYAL 9 card combination progressive payout table;
providing at or proximate to the at least one playing table at least one standard 52-card deck of physical playing cards randomized to form at least one 52-card deck of Baccarat physical playing cards;
providing an electronic means for sensing and reporting ROYAL 9 progressive bonus bets at the at least one playing table, programmable means for calculating a percentage of the ROYAL 9 progressive bonus bets to create at least one ROYAL 9 Progressive cumulative jackpot and providing at least one electronic ROYAL 9 progressive meter display at a location visible to each player at the at least one playing table, and an electronic means for updating the ROYAL 9 progressive meter display with at least one ROYAL 9 progressive jackpot cumulative payout amount based on a percentage of all ROYAL 9 progressive bonus bets made;
receiving one bet taken from one of the three Baccarat alternate betting locations including a Baccarat Player Hand win bet, a Baccarat Banker Hand win bet, or a Baccarat Banker Hand and Baccarat Player Hand tie bet in the form of at least one physical physical monetary token placed in the associated Baccarat Player Hand betting location, the Baccarat Banker Hand win betting location, or the Baccarat Banker Hand and Baccarat Player Hand tie betting location of each player layout area of the plurality of player layout areas where a bet has been made;
receiving an optional ROYAL 9 progressive bonus bet in the form of at least one physical monetary token placed in the ROYAL 9 progressive optional bonus betting location of each player layout area of the plurality of player layout areas where a bet has been made;
recording and locking in all ROYAL 9 bonus wagers;
collecting all ROYAL 9 bonus wagers;
distributing, on the surface of the playing table and from the at least one randomized 52-card deck of physical Baccarat playing cards, a two-card face-up Baccarat Banker Hand and a two-card face-up Baccarat Player Hand;
analyzing the initial dealt two-card face-up Baccarat Banker Hand and the initial dealt two-card face-up Baccarat Player Hand to determine if the Baccarat Player Hand, the Baccarat Banker Hand, or both contain a ROYAL 9 card combination;
paying out any winning ROYAL 9 progressive bonus bets according to the ROYAL 9 progressive payout table; and
playing out the Baccarat hand in accordance with approved Baccarat procedures.

2. The method of claim 1 wherein the player layout location indicating at least one unique player individually assigned ROYAL 9 card combination comprises a location indicating three unique ROYAL 9 combinations assigned to the single player location comprising a unique King and Nine card combination, a unique Queen and Nine card combination, and a unique Jack and Nine card combination; and paying out any winning ROYAL 9 Progressive bonus bets according to the ROYAL 9 card combination Personal Progressive payout table comprises paying out to a ROYAL 9 progressive optional bonus betting player:
100% of a Major Progressive meter for an Exact Match Personal Progressive, having both the Banker Hand and the Player Hand exactly matching of one of the optional bonus betting player's uniquely assigned ROYAL 9 card combinations;
10% of the Major Progressive meter for Any Two Personal Progressives, having the Banker Hand matching one of the optional betting player's uniquely assigned ROYAL 9 card combinations and the Player Hand matching another of the optional bonus betting player's uniquely assigned ROYAL 9 card combinations.

3. The method of claim 2 further comprising paying out any winning ROYAL 9 Progressive bonus bets according to the ROYAL 9 card combination Personal Progressive payout table comprising paying out to a ROYAL 9 Progressive optional bonus betting player:
100% of a King 9 Banker Progressive meter for the Banker Hand having a King 9 card combination matching the optional betting player's uniquely assigned King 9 card combination;
100% of a King 9 Player Progressive meter for the Player Hand having a King 9 card combination matching the optional betting player's uniquely assigned King 9 card combination.

4. The method of claim 1 wherein paying out any winning ROYAL 9 Progressive bonus bets according to the ROYAL 9 card combination general Progressive payout table comprises paying out to a ROYAL 9 progressive optional bonus betting player:
$1,500 for any Suited ROYAL 9 Tie Hand
$250 for any ROYAL 9 Tie Hand
$50 for any Suited ROYAL 9
$25 for any ROYAL 9.

5. The method of claim 1 wherein providing at or proximate to the at least one playing table at least one standard 52-card deck of physical playing cards comprises providing any of the numbers of standard 52-card decks of playing cards taken from the list of decks including one deck, two decks, four decks, six decks, and eight decks randomized to form a deck of Baccarat physical playing cards.

6. The method of claim 1 wherein providing at least one playing table comprises providing a plurality of playing tables all contributing to the ROYAL 9 progressive jackpot.

7. The method of claim 1, wherein providing a playing table comprises providing a table surface having the plurality of player layout areas defined at a playing surface thereof.

8. (canceled)

9. A method of administering a Baccarat casino card game in combination with an optional progressive award bonus bet on a ROYAL 9 card combination of a face card and a nine card including at least one unique individual ROYAL 9 card combination of a face card and a nine card combination of specified suits assigned to each player position, the method comprising:
providing an electronic simulation device comprising a screen configured to display a virtual representation of a playing surface illustrated to define a dealer layout area and a plurality of player layout areas, each player layout area of the plurality of player layout areas illustrated to define a plurality of distinct locations comprising a Baccarat Player Hand win betting location, a Baccarat Banker Hand win betting location, a Baccarat Banker Hand and Baccarat Player Hand tie betting location, a ROYAL 9 progressive optional bonus betting location for dealt Banker Hand and Player Hand ROYAL 9 card combinations of a face card and a nine card progressive award bonus wins, a location indicating at least one unique player individually assigned ROYAL 9 card combination of a face card and a nine card of specified suits, and a ROYAL 9 card combination progressive payout table;
providing at least one standard 52-card deck of virtual playing cards randomized to form at least one 52-card deck of virtual Baccarat playing cards;
providing an electronic means for recording individual player ROYAL 9 progressive bets on the at least one virtual representation of a playing surface and providing at least one virtual representation of a ROYAL 9 progressive meter display, and an electronic means for updating the ROYAL 9 progressive meter display with at least one ROYAL 9 progressive jackpot cumulative payout amount based on a percentage of all ROYAL 9 progressive bonus bets made;
receiving one bet taken from one of the three Baccarat alternate betting locations including a Baccarat Player Hand win bet, a Baccarat Banker Hand win bet, or a Baccarat Banker Hand and Baccarat Player Hand tie bet, the bet in the form of at least one virtual monetary token virtually indicated in the associated Baccarat Player Hand betting location, the Baccarat Banker Hand win betting location, or the Baccarat Banker Hand and Baccarat Player Hand tie betting location of each player layout area of the plurality of player layout areas where a bet has been made;
receiving an optional ROYAL 9 progressive bonus bet in the form of at least one virtual monetary token virtually indicated in the ROYAL 9 progressive optional bonus betting location of each player layout area of the plurality of player layout areas where a bet has been made;
recording and locking in all ROYAL 9 bonus wagers;
collecting all ROYAL 9 bonus wagers;
virtually distributing, on the virtual representation of a playing surface, from the at least one randomized 52-card deck of virtual Baccarat playing cards, a two-card face-up Baccarat Banker Hand and a two-card face-up Baccarat Player Hand;
analyzing the initial dealt two-card face-up Baccarat Banker Hand and the initial dealt two-card face-up Baccarat Player Hand to determine if the Baccarat Player Hand, the Baccarat Banker Hand, or both contain a ROYAL 9 card combination;
paying out any winning ROYAL 9 progressive bonus bets according to the Royal 9 card combination progressive payout table; and
playing out the Baccarat hand in accordance with approved Baccarat procedures.

10. The method of claim 9 wherein indicating at least one unique player individually assigned ROYAL 9 card combination comprises indicating three unique ROYAL 9 combinations assigned to the single player location comprising a unique King and Nine card combination, a unique Queen and Nine card combination, and a unique Jack and Nine card combination; and paying out any winning ROYAL 9 Progressive bonus bets according to the ROYAL 9 card combination Personal Progressive payout table comprises paying out to a ROYAL 9 progressive optional bonus betting player:
100% of a Major Progressive meter for an Exact Match Personal Progressive, having both the Banker Hand and the Player Hand exactly matching of one of the optional bonus betting player's uniquely assigned ROYAL 9 card combinations;
10% of the Major Progressive meter for Any Two Personal Progressives, having the Banker Hand matching one of the optional betting player's uniquely assigned ROYAL 9 card combinations and the Player Hand matching another of the optional bonus betting player's uniquely assigned ROYAL 9 card combinations.

11. The method of claim 10 further comprising paying out any winning ROYAL 9 Progressive bonus bets according to the ROYAL 9 card combination Personal Progressive payout table comprising paying out to a ROYAL 9 Progressive optional bonus betting player:
100% of a King 9 Banker Progressive meter for the Banker Hand having a King card combination matching the optional betting player's uniquely assigned King card combination;
100% of a King 9 Player Progressive meter for the Player Hand having a King 9 card combination matching the optional betting player's uniquely assigned King card combination.

12. The method of claim 9 wherein paying out any winning ROYAL 9 Progressive bonus bets according to the ROYAL 9 card combination general Progressive payout table comprises paying out to a ROYAL 9 progressive optional bonus betting player:
$1,500 for any Suited ROYAL 9 Tie Hand
$250 for any ROYAL 9 Tie Hand
$50 for any Suited ROYAL 9
$25 for any ROYAL 9.

13. The method of claim 9 wherein providing at least one standard 52-card deck of virtual playing cards comprises providing any of the numbers of standard 52-card decks of virtual playing cards taken from the list of numbers of standard 52-card decks of virtual playing cards including one deck, two decks, four decks, six decks, and eight decks randomized to form a virtual deck of Baccarat playing cards.

14. The method of claim 9, wherein providing an electronic simulation device comprises providing a handheld electronic simulation device, the screen of the electronic simulation device configured as a touch screen of the handheld electronic simulation device.

15. The method of claim 9, wherein providing an electronic simulation device comprises providing an electronic simulation device having a connection to a remote network.

16. The method of claim 15, wherein providing an electronic simulation device having a connection to a remote network comprises providing the electronic simulation device having a wired connection to the remote network.

17. The method of claim 15, wherein providing an electronic simulation device having a connection to a remote network comprises providing the electronic simulation device having a wireless connection to the remote network.

18. The method of claim 15, wherein providing an electronic simulation device having a connection to a remote network comprises providing a communication electronic simulation device having the connection to the remote network.

19. The method of claim 9, wherein providing an electronic simulation device comprises providing at least one of a computer, a handheld device, a telephonic device, an entertainment device, a gaming device, and a television device.

20. The method of claim 9 wherein providing at least one electronic simulation device comprises providing a plurality of electronic simulation devices all contributing to the ROYAL 9 progressive jackpot.
